(19) United States
(12) Patent Application Publication
(10) Pub. No.: US 2013/0286192 A1
(43) Pub. Date: Oct. 31, 2013

(54) Machine Vision System for Frozen Aliquotter for Biological Samples

(71) Applicants: Mohammadreza Ramezanifard, Watertown, MA (US); Saeed Sokhanvar, Cambridge, MA (US)

(72) Inventors: Mohammadreza Ramezanifard, Watertown, MA (US); Saeed Sokhanvar, Cambridge, MA (US)

(73) Assignee: CRYOXTRACT INSTRUMENTS, LLC, Arlington, VA (US)

(21) Appl. No.: 13/489,234

(22) Filed: Jun. 5, 2012

Related U.S. Application Data
(60) Provisional application No. 61/640,662, filed on Apr. 30, 2012.

(51) Int. Cl. H04N 7/18

(52) U.S. Cl. 348/135; 348/E07.085; 901/47

(57) ABSTRACT

A machine vision system for use with a system that takes frozen sample cores from samples that are in containers includes a camera. A processor is configured to receive image data from the camera and to determine locations where frozen sample cores have already been taken. A method of determining one or more locations where a frozen sample core have already been taken from frozen samples includes operating a robotic system to position one of the containers on a platform at a station for receiving the container while a frozen sample core is extracted from the frozen sample contained in the container. The camera is used to capture an image of the frozen sample. Contrast in the captured image is evaluated to identify one or more bore candidates. The processor uses the image to determine whether or not the bore candidates are real bores or artifacts.

### FIELD OF INVENTION

The present invention relates generally to machine vision systems and methods, and more particularly to machine vision systems for facilitating control of robotic systems for taking multiple frozen sample cores from frozen samples in containers without thawing the frozen samples.

### BACKGROUND

Biological samples are commonly preserved to support a broad variety of biomedical and biological research that includes but is not limited to translational research, molecular medicine, and biomarker discovery. Biological samples include any samples which are of animal (including human), plant, protozoal, fungal, bacterial, viral, or other biological origin. For example, biological samples include, but are not limited to, organisms and/or biological fluids isolated from or excreted by an organism such as plasma, serum, urine, whole blood, cord blood, other blood-based derivatives, cerebral spinal fluid, mucus (from respiratory tract, cervical), ascites, saliva, amniotic fluid, seminal fluid, tears, sweat, any fluids from plants (including sap); cells (e.g., animal, plant, protozoal, fungal, or bacterial cells, including buffy coat cells; cell lysates, homogenates, or suspensions; microsomes; cellular organelles (e.g., mitochondria); nucleic acids (e.g., RNA, DNA), including chromosomal DNA, mitochondrial DNA, and plasmids (e.g., seed plasmids); small molecule compounds in suspension or solution (e.g. small molecule compounds in DMSO); and other fluid-based biological samples. Biological samples may also include plants, portions of plants (e.g., seeds) and tissues (e.g., muscle, fat, skin, etc.).

Biobanks typically store these valuable samples in containers (e.g., well plates or arrays, tubes, vials, or the like) and cryopreserve them. Tubes, vials, and similar containers can be organized in arrays and can be stored in well plates, racks, divided containers, etc. Although some samples are stored at relatively higher temperatures (e.g., about −20 degrees centigrade), other samples are stored at much lower temperatures. For example some samples are stored in freezers at −80 degrees centigrade, or lower using liquid Nitrogen or the vapor phase above liquid Nitrogen) to preserve the biochemical composition and integrity of the frozen sample as close as possible to the in vivo state to facilitate accurate, reproducible analyses of the samples.

From time to time, it may be desirable to run one or more tests on a sample that has been frozen. For example, a researcher may want to perform tests on a set of samples having certain characteristics. A particular sample may contain enough material to support a number of different tests. In order to conserve resources, smaller samples known as aliquots are commonly taken from larger cryopreserved samples (which are sometimes referred to as parent samples) for use in one or more tests so the remainder of the parent sample will be available for one or more different future tests.

Biobanks have adopted different ways to address this need to provide sample aliquots. One option is to freeze a sample in large volume, thaw it when aliquots are requested and then refreeze any remainder of the parent sample for storage in the cryopreserved state until future aliquots are needed. This option makes efficient use of frozen storage space; yet this efficiency comes at the cost of sample quality. Exposing a sample repeatedly to freeze/thaw cycles can degrade the sample's critical biological molecules (e.g., RNA) and damage biomarkers, either of which could compromise the results of any study using data obtained from the damaged samples.

Another option is to freeze a sample in large volume, thaw it when an aliquot is requested, subdivide the remainder of the parent sample in small volumes to make additional aliquots for future tests and then refreeze these smaller volume aliquots to cryopreserve each aliquot separately until needed for a future test. This approach limits the number of freeze/thaw cycles to which a sample is exposed, but there is added expense associated with the larger volume of frozen storage space, labor, and larger inventory of sample containers (e.g. tubes, vials, or the like) required to maintain the cryopreserved aliquots. Moreover, the aliquots can be degraded or damaged by even a limited number freeze/thaw cycles.

Yet another approach is to divide a large volume sample into smaller volume aliquots before freezing them for the first time. This approach can limit the number of freeze thaw cycles to which a sample may be subjected to only one; yet, there are disadvantages associated with the costs of labor, frozen storage space, and sample container inventory requirements with this approach.

U.S. pre-grant publication No. 20090019877, the contents of which are hereby incorporated by reference, discloses a system for extracting frozen sample cores from a frozen biological sample without thawing the original (parent) sample. The system uses a drill including a hollow coring bit to take a frozen core sample from the original parent sample without thawing the parent sample. The frozen sample core obtained by the drill is used as the aliquot for the test. After the frozen core is removed, the remainder of the sample is returned to frozen storage in its original container until another aliquot from the parent sample is needed for a future test.

The present inventors have developed systems and methods, which will be described below, that facilitate automatic recognition of whether or not a frozen sample contains any bores from previous extraction of one or more frozen sample cores as well as the positions of any such bores to implement automatic extraction of further frozen sample cores from the sample.

### SUMMARY

One aspect of the invention is a machine vision system for use with a robotic system for taking a plurality of frozen sample cores from frozen samples that are each contained in a respective container. The machine vision system includes a platform for supporting one or more of the containers. The platform has a station for receiving at least one of the containers and a pair of calibration marks on the platform in fixed positions relative to the station. The system has a camera for capturing an image of the container while the container is received at the station. A processor is configured to receive image data from the camera indicative of the image of the container. The processor is configured to determine one or more locations where a frozen sample core has already been taken from a frozen sample contained in the container by: (a) evaluating contrast in the image to identify one or more bore candidates; and (b) using information about the position of the calibration marks relative to the bore candidates to determine whether or not the one or more candidates are likely to be artifacts instead of real bores in the sample.

Another aspect of the invention is a method of taking a frozen sample core from a frozen sample that is contained in a container. The method includes positioning the container at a station for receiving a container on a platform. The platform has a pair of calibration marks on the platform in fixed positions relative to the station. An image of the container is captured while the container is received at the station. One or more locations where a frozen sample core has already been taken from the frozen sample contained in the container is determined by: (a) evaluating contrast in the image to identify one or more bore candidates; and (b) using information about the position of the calibration marks relative to the bore candidates to determine whether or not the one or more candidates are likely to be artifacts instead of real bores in the frozen sample. A frozen sample core is taken from the sample at a location from which no frozen sample core has already been taken, as determined in the determining step.

Yet another aspect of the invention is a machine vision system for use with a robotic system for taking a plurality of frozen sample cores from frozen samples that are each contained in a respective container. The machine vision system includes a platform and a camera for capturing an image of one of the containers while it is on the platform. A processor is configured to receive image data from the camera indicative of the image captured by the camera. The processor is configured to determine one or more locations where a frozen sample core has already been taken from the frozen sample contained in the container by: (a) evaluating contrast in the image to identify one or more bore candidates; and (b) determining whether or not the one or more bore candidates are likely to be artifacts instead of real bores in the sample. The processor is configured to use at least one of the following to determine whether or not the one or more bore candidates are likely to be artifacts: (i) the size of the bore candidate; (ii) the distance between the bore candidate and a center axis of the container; (iii) the angle formed between a first line and a second line, the first line extending between the bore and the center axis of the container and the second line extending between the center axis of the container and another bore candidate; (iv) the relation between the position of the one or more bore candidates and an expected pattern of bores in the sample; (v) the location of the one or more bore candidates relative to a peripheral edge of the container; (vi) the number of bore candidates identified; (vii) the amount of contrast between the bore candidates and the area surrounding the bore candidates; and (viii) combinations thereof.

Another aspect of the invention is a method of taking a frozen sample core from a frozen sample that is contained in a container. The method includes capturing an image of the container. The captured image is used to determine one or more locations where a frozen sample core has already been taken from the frozen sample contained in the container by: (a) evaluating contrast in the image to identify one or more bore candidates; and (b) determining whether or not the one or more bore candidates are likely to be artifacts instead of real bores in the frozen sample. At least one of the following pieces of information is used to determine whether or not the one or more bore candidates are likely to be artifacts instead of real bores: (i) the size of the bore candidate; (ii) the distance between the bore candidate and a center axis of the container; (iii) the angle formed between a first line and a second line, the first line extending between the bore and the center axis of the container and the second line extending between the center axis of the container and another bore candidate; (iv) the relation between the position of the one or more bore candidates and an expected pattern of bores in the frozen sample; (v) the location of the one or more bore candidates relative to a peripheral edge of the container; (vi) the number of bore candidates identified; (vii) the amount of contrast between the bore candidates and the surrounding areas; and (viii) combinations thereof. A frozen sample core is taken from the sample at a location from which no frozen sample core has already been taken, as determined in the determining step.

Another aspect of the invention is a calibration system configured to calibrate a robotic system for taking a plurality of frozen sample cores from frozen samples that are each contained in a respective container. The calibration system includes a platform for supporting the containers. The platform having one or more fixed targets positioned thereon. A camera is mounted on the robotic system for capturing an image of one or more containers while the containers are supported by the platform and for capturing images of the one or more fixed targets positioned on the platform. A processor is configured to receive image data from the camera indicative of images formed by the camera. The processor is configured to calibrate the robotic system using an image of the one or more fixed targets on the platform.

Another aspect of the invention is a method of calibrating a robotic system for taking a plurality of frozen sample cores from frozen samples that are each contained in a respective container. The method includes using a camera for capturing an image of one or more containers while the containers are supported by a platform of the robotic system to determine whether or not one or more frozen sample cores has already been taken from the frozen sample to capture an image of one or more fixed targets on the platform. The image of the one or more targets is used to calibrate the robotic system.

Another aspect of the invention is a machine vision system for use with a robotic system adapted for taking a plurality of frozen sample cores from frozen samples that are each contained in a container. The machine vision system includes a camera for capturing an image of a container while the container is supported by a platform. The camera has an optical axis. The system has a ring light for illuminating the container on the platform. The ring light includes a plurality of light sources arranged in an annular patter. The optical axis of the camera extends through a central portion of the annular pattern. A processor is adapted to receive image data from the camera indicative of the image captured by the camera and to determine one or more locations where a frozen sample core has already been taken from the sample contained in the container by evaluating contrast in the image.

Still another aspect of the invention is a method of determining one or more locations where frozen sample core have already been taken from frozen samples, each of the frozen samples being contained in a respective container. The method includes operating a robotic system to move a camera relative to a first one of the containers so the camera is directed at the frozen sample in the first container. The frozen sample is illuminated using a ring light. The ring light has a plurality of light sources arranged in an annular pattern. The camera has an optical axis that extends through a central portion of the annular pattern. The camera is used to capture an image of the illuminated frozen sample. Contrast in the captured image is evaluated and the image is processed to identify one or more bore candidates in the captured image and determine whether or not the bore candidates are likely to be artifacts or real bores in the frozen sample. The robotic system is operated to move the camera relative to a second of the containers so the camera is directed at the frozen sample in the second container. The imaging is repeated for the frozen sample in the second container.

Yet another aspect of the invention is a machine vision system for use with a robotic system for taking a plurality of frozen sample cores from frozen samples that are each contained in a container. The system includes a camera configured for capturing monochrome images of the containers while the containers are supported by a platform. A light is positioned to illuminate the containers and the samples contained therein while the containers are on the platform. A processor is adapted to receive grayscale image data from the camera indicative of images formed by the camera and determine locations where frozen sample cores have already been taken from the samples by evaluating contrast in the images. The light emits light having a color other than white.

Another aspect of the invention is a method of determining one or more locations where frozen sample core have already been taken from frozen samples. Each of the frozen samples is contained in a respective container. The method includes operating a robotic system to move a camera relative to a first one of the containers so the camera is directed at the frozen sample in the first container. The frozen sample is illuminated with a colored light. The camera is used to capture a grayscale image of the illuminated frozen sample. Contrast in the captured image is evaluated and the image is processed to identify one or more bore candidates in the captured image and determine whether or not the bore candidates are likely to be artifacts or real bores in the frozen sample. The robotic system is operated to move the camera relative to a second of the containers so the camera is directed at the frozen sample in said second container. The imaging is repeated for the frozen sample in the second container.

Another aspect of the invention is a machine vision system for use with a robotic system for taking a plurality of frozen sample cores from frozen samples that are each contained in a container. The system includes a camera for taking images of the containers while the containers are supported by a platform. A light is positioned to illuminate the containers and the samples contained therein while the containers are on the platform. The light has red light emitting elements, blue light emitting elements, and green light emitting elements. The intensity of light emitted from the red, blue, and green light emitting elements is selectively adjustable to allow any of multiple different colors of light to be selected as the color of light to be emitted by the light. A processor is adapted to receive image data from the camera indicative of images formed by the camera and determine locations where frozen sample cores have already been taken from the samples by evaluating contrast in the images. The processor is adapted to receive input about the color of the samples in the containers and adjust the color of the light emitted by the light to reduce a difference between the color of the samples and the color of the light emitted by the light.

Another aspect of the invention is a method of determining one or more locations where frozen sample core have already been taken from frozen samples. Each of the frozen samples is contained in a respective container. The method includes operating a robotic system to move a camera relative to a first one of the containers so the camera is directed at the frozen sample in the first container. The frozen sample is illuminated with a colored light. The color of the light is selected to match the color of the frozen sample. The camera is used to capture an image of the illuminated frozen sample. Contrast in the captured image is evaluated and the image is processed to identify one or more bore candidates in the captured image and determine whether or not the bore candidates are likely to be artifacts or real bores in the frozen sample. The robotic system is operated to move the camera relative to a second of the containers so the camera is directed at the frozen sample in said second container. The imaging process is repeated for the frozen sample in the second container.

Another aspect of the invention is a machine vision system for use with a robotic system for taking a plurality of frozen sample cores from frozen samples that are each contained in a container. The machine vision system includes a platform for supporting the containers. The platform has a station for receiving one of the containers while a frozen sample core is extracted from a frozen sample contained in the container. The system has a camera for capturing images of containers while they are received at the station on the platform. A light is positioned to illuminate the containers from a position providing at least one of back lighting and side lighting.

Yet another embodiment of the invention is a method of determining one or more locations where frozen sample core have already been taken from frozen samples. Each of the frozen samples is contained in a respective container. The method includes operating a robotic system to position one of the containers on a platform at a station for receiving the container while a frozen sample core is extracted from the frozen sample contained in the container. A light is used to provide at least one of back lighting and side lighting for the container. A camera is used to capture an image of the frozen sample while illuminated by the light. Contrast in the captured image is evaluated and the image is processed to identify one or more bore candidates in the captured image.

Another inventive aspect is a machine vision system for use with a robotic system adapted for taking a plurality of frozen sample cores from frozen samples that are each contained in a container. The machine vision system includes a camera for capturing an image of a container while the container is supported by a platform at a station for receiving the container while a frozen sample core is extracted from the frozen sample contained therein. The system has a red light for illuminating the container from above while it is on the platform at the station with substantially monochromatic red light. A processor is adapted to receive image data from the camera indicative of the image captured by the camera and to determine one or more locations where a frozen sample core has already been taken from the sample contained in the container by evaluating contrast in the image.

Yet another aspect of the invention is a method of determining one or more locations where a frozen sample core have already been taken from frozen samples. Each of the frozen samples is contained in a respective container. The method includes operating a robotic system to position one of the containers on a platform at a station for receiving the container while a frozen sample core is extracted from the frozen sample contained in the container. The container is illuminated from above while it is on the platform at the station with substantially monochromatic red light. A camera is used to capture an image of the frozen sample while illuminated by the red light. Contrast in the captured image is evaluated and the image is processed to identify one or more bore candidates in the captured image.

Another aspect of the invention is a machine vision system for use with a robotic system for taking a plurality of frozen sample cores from frozen samples that are each contained in a respective container. The machine vision system includes a platform for supporting one or more of the containers. The platform having a station for receiving at least one of the containers. The system has a camera for capturing an image of the container while the container is received at the station. A processor is configured to receive image data from the camera indicative of the image of the container. The processor is configured to determine one or more locations where a frozen sample core has already been taken from a frozen sample contained in the container by evaluating contrast in the image to identify one or more bore candidates and identify an edge of the container and using information about the position of the edge relative to the bore candidates to determine whether or not the one or more candidates are likely to be artifacts instead of real bores in the sample.

Another aspect of the invention is a method of determining one or more locations where a frozen sample core have already been taken from frozen samples. Each of the frozen samples is contained in a respective container. The method includes operating a robotic system to position one of the containers on a platform at a station for receiving the container while a frozen sample core is extracted from the frozen sample contained in the container. A camera is used to capture an image of the frozen sample. Contrast in the captured image is evaluated to identify one or more bore candidates and identify an edge of the container. Information about the position of the edge relative to the bore candidates is used to determine whether or not the one or more candidates are likely to be artifacts instead of real bores in the sample.

Other objects and features will in part be apparent and will in part be pointed out hereinafter.

### BRIEF DESCRIPTION OF THE DRAWINGS

FIG. 1 is perspective of one example of a frozen aliquotter including one embodiment of a machine vision system of the present invention;

FIG. 2 is a top plan of the frozen aliquotter;

FIG. 3 is a top plan of the frozen aliquotter with parts removed to avoid obstructing view of one embodiment of a platform thereof;

FIG. 4 is an enlarged perspective of the platform taken in a plane including line 4-4 on FIG. 4

FIG. 5 is a perspective of a fragment of the frozen aliquotter shown in cross section taken in a plane including line 5-5 on FIG. 2;

FIG. 6 is a perspective of one embodiment of robotic end effector for use with a frozen aliquotter;

FIG. 7 is a bottom plan view of the robotic end effector illustrated in FIG. 6;

FIG. 8 is a schematic diagram showing some of the components of the frozen aliquotter;

FIG. 9 is a schematic diagram illustrating bore candidates that differ in size;

FIG. 10 is a schematic diagram illustrating one embodiment of a geometric pattern according to which frozen sample cores are extracted from a frozen sample;

FIG. 11 is a schematic diagram illustrating bore candidates that spaced different distances from a center of a container;

FIG. 12 is a schematic diagram illustrating bore candidates that are positioned at various different angles relative to one another from a center of the container;

FIG. 13 is a schematic diagram illustrating bore candidates that do not follow an expected sequence planned for extraction of frozen sample cores from a frozen sample;

FIG. 14 is a photograph of a container illustrating use of an edge finding algorithm to identify the location of an edge of the container from the image data;

FIG. 15 is a schematic diagram illustrating one embodiment of using fixed calibration marks to identify the location of features in the image data;

FIG. 16 is a photograph showing a pair of calibration marks in fixed position relative to a container; and

FIG. 17 is a photograph of one embodiment of a density step target.

Corresponding reference characters indicate corresponding parts throughout the drawings.

### DETAILED DESCRIPTION

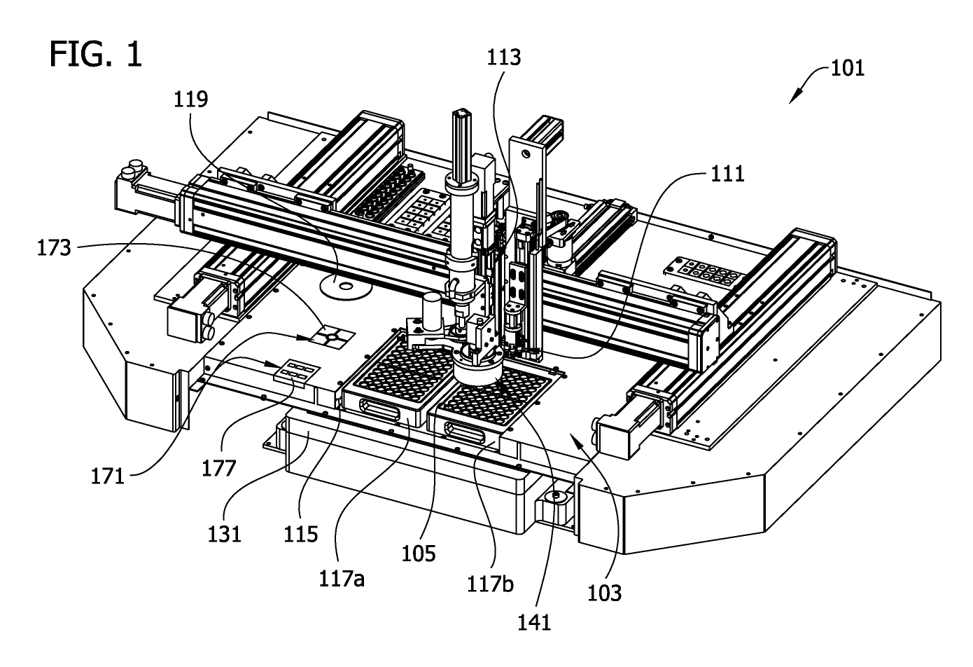

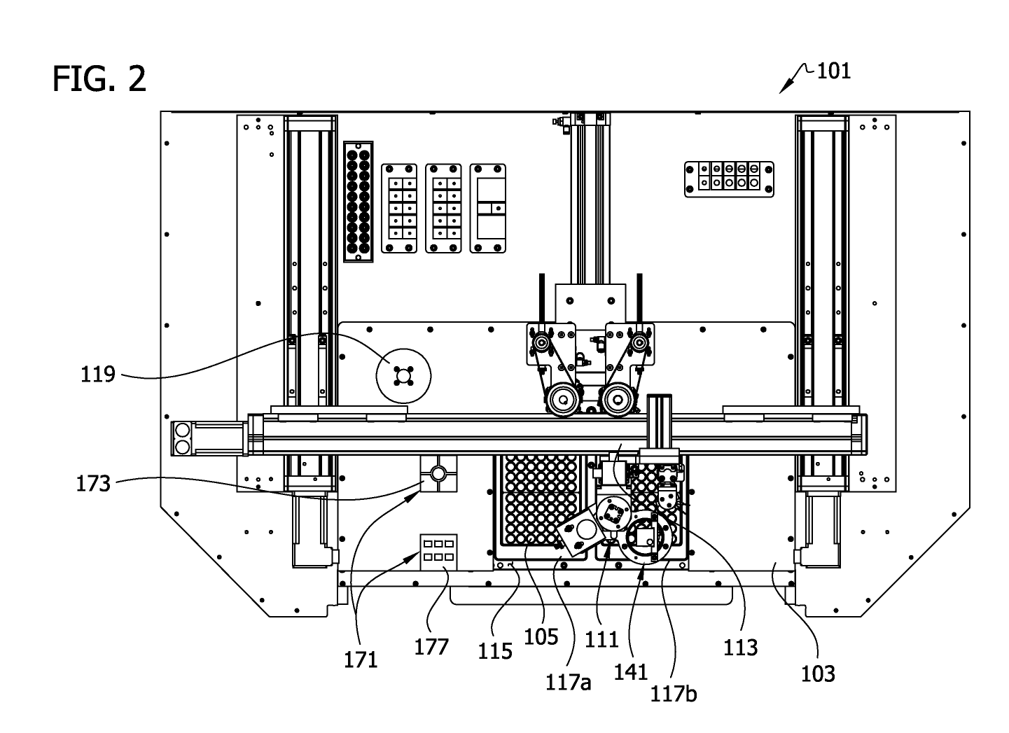

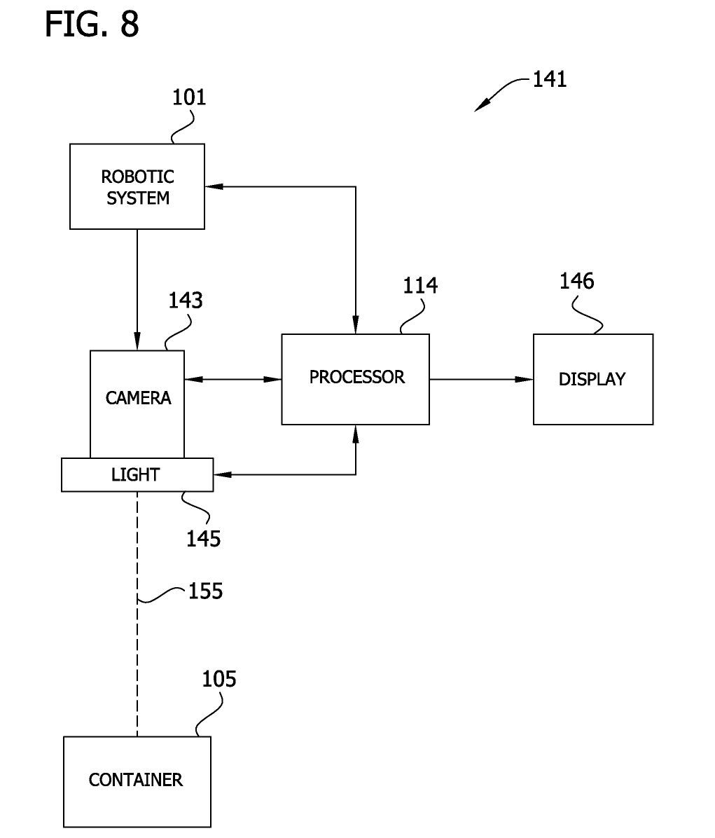

Referring now to the drawings, first to FIGS. 1-3 in particular, one embodiment of a robotic system for taking frozen sample cores from frozen samples contained in containers is generally designated 101. The system 101 includes a platform 103 for supporting a plurality of containers 105 and a robotic end effector 111 movable relative to the platform by a motorized drive system 113 controlled by a processor 114 (FIG. 8). In the illustrated embodiment, the robotic system 101 is a cartesian gantry style robot, but this is not required and other types of robotic systems can be used within the scope of the invention. Additional details about robotic systems for taking frozen sample cores from frozen samples are set forth in U.S. pre-grant publication No. 20090019877, PCT application No. PCT/US2011/61214, filed Nov. 17, 2011, and U.S. application Ser. No. 13/359,301, filed Jan. 26, 2012, the contents of which are each hereby incorporated by reference.

In the illustrated embodiment, the platform 103 includes a recessed area 115 sized and shaped to receive one or more removable trays 117 for holding the containers 105. For example, one or more of the trays 117a are suitably source trays that hold a plurality of source containers 105, each of which contains a frozen sample core is to be taken, and one or more other trays 117b are suitably destination trays that hold a plurality of destination containers, each of which is for use holding one or more frozen sample cores taken from the containers on the source tray.

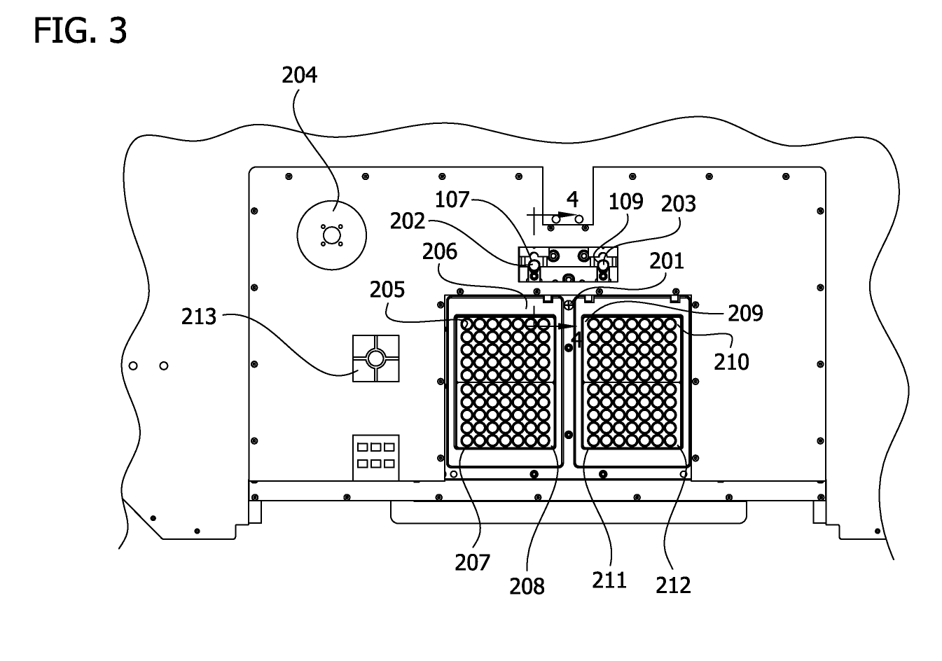

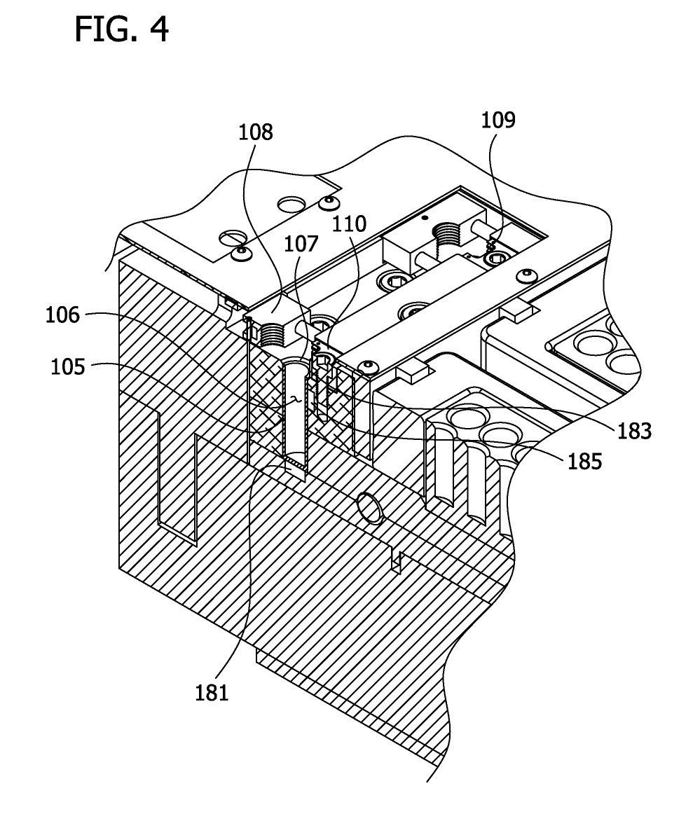

As illustrated in FIGS. 3 and 4, the platform 103 also includes a source container station 107 adapted to receive one of the source containers while a frozen sample core is extracted from the frozen sample container therein and a destination container station 109 adapted to receive an empty container in which one or more frozen sample cores are deposited. As illustrated in FIG. 4, the source container station 107 includes a receptacle 106 for receiving containers 105 and a pair of clamping jaws 108, 110 on opposite sides at the top of the receptacle. At least one of the jaws 108 is selectively moveable, such as by a pneumatic actuator (not shown), toward and away from the other jaw 110 for selectively clamping containers 105 in position at the station 107 to hold them in place during extraction of a frozen sample and releasing the containers so they can be removed from the station and replaced in the tray 117 afterward. Similar jaws can be used to hold the container 105 at the sample receiving station 109 if desired.

The system 101 illustrated in the drawings is adapted for use with frozen samples that are stored in individual containers 105. However, it is understood the system could be adapted for use with well plates and arrays in which multiple different frozen samples are stored in a single container. For example, appropriate components can be provided (e.g., on the end effector) for moving well plates or arrays instead of individual containers and the stations 107, 109 for receiving the containers can be adapted to receive well plates or arrays without departing from the scope of the invention. Likewise, the clamping system can be adapted to hold well plates and arrays within the scope of the invention.

A washing station 119 for cleaning a sample coring probe 121 used to extract frozen sample cores from the frozen samples is also on the platform. Details concerning the construction and operation of a suitable washing station are provided in PCT application No. PCT/US2011/61214, filed Nov. 17, 2011, and do not need to be repeated herein.

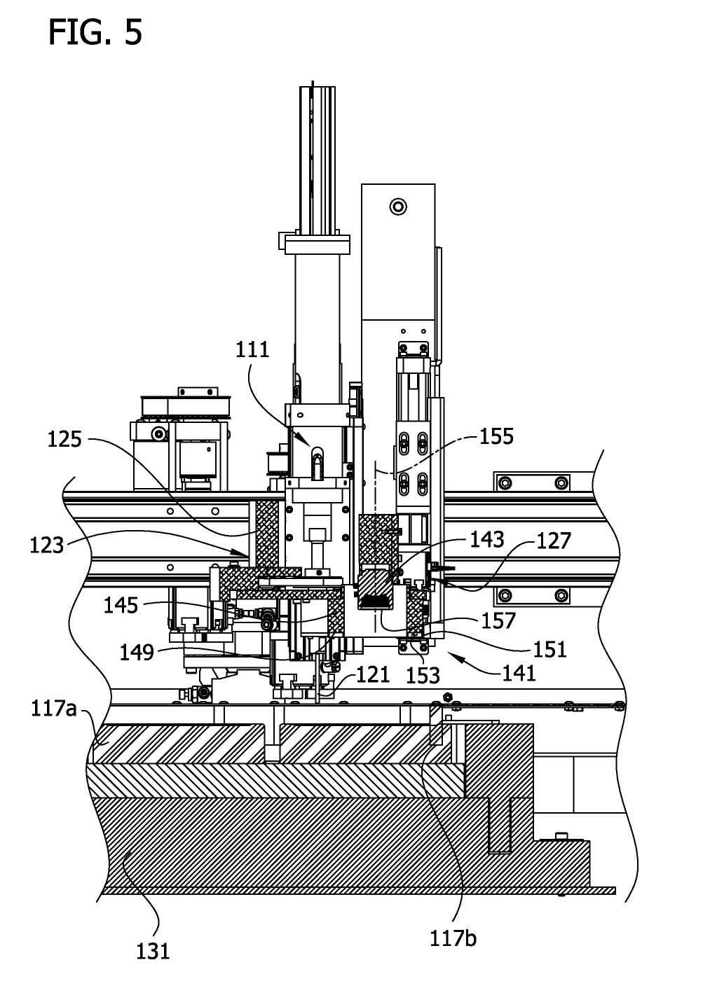

A cooling system 131 for keeping the frozen samples and the frozen sample cores extracted therefrom frozen is positioned under the platform 103 in the illustrated embodiment, although the cooling system can be positioned elsewhere and/or other cooling systems used without departing from the scope of the invention. As illustrated in FIGS. 5-7, the end effector 111 of the robotic system 101 includes a sample coring probe 121 and a sample core extraction system 123 operable to move the sample coring probe into one of the frozen samples contained in one of the containers 105 and then withdraw the coring probe from the frozen sample to obtain a frozen sample core from the frozen sample. In the illustrated embodiment, for example, the sample core extraction system 123 includes a motor 125 adapted to rotate the sample coring probe 123 as the robotic drive system 113 lowers the sample coring probe into the container and then raises it out of the container. Additional details about the operation of a coring probe to extract frozen sample cores from frozen samples are set forth in U.S. pre-grant publication No. 20090019877, PCT application No. PCT/US2011/61214, filed Nov. 17, 2011, and U.S. application Ser. No. 13/359,301, filed Jan. 26, 2012 and do not need to be repeated herein. It is understood any sample coring probe and sample extraction system can be used within the scope of the invention, as long as they can be operated to extract a frozen sample core from a frozen sample while resulting in only limited to no thawing of the frozen sample material and the frozen sample core extracted therefrom.

The end effector 111 also includes a gripping system 127 operable to selectively hold and release containers 105 for use by the robotic system 101 in moving containers back and forth between the trays 117 and the stations 107, 109 on the platform for the containers from which frozen sample cores are being taken and into which frozen sample cores are being deposited. Those skilled in the art will be familiar with various commercially available gripping systems that can be used. In the illustrated embodiment, for example, the gripping system includes a plurality of moveable fingers 129 moveable by one or more pneumatic actuators (not shown) under the control of the processor 114. It is understood other gripping systems may be used within the scope of the invention. For example, the gripping system can be modified if desired to facilitate use of the gripping system to move well plates or arrays containing multiple frozen samples.

As illustrated schematically in FIG. 8, the robotic system 101 cooperates with a machine vision system 141 configured to automatically recognize locations from which frozen sample cores have already been taken from the frozen samples in the containers 105 (if there are any) to facilitate taking additional frozen sample cores from already-cored frozen samples. At these locations, there will be a bore or hole in the frozen sample. In some cases the bore may be empty, but in other cases the bore may contain or be obscured by frost crystals that have grown on the sample (e.g., while the sample was in frozen storage), by debris, and/or for other reasons. The machine vision system 141 is also configured to recognize the absence of any bores in frozen samples that have not yet had any frozen sample cores extracted from them. The machine vision system 141 facilitates use of the robotic system 101 to take frozen sample cores from frozen samples that were previously sampled to obtain an aliquot and then were returned to frozen storage for a period of time before additional frozen sample cores from that sample are requested to provide additional aliquots in later tests.

The machine vision system 141 includes a camera 143 mounted for capturing an image of a container 105 and a frozen sample contained therein while the container is supported by the platform 103. In the illustrated embodiment, the machine vision system 141 includes a display 146 coupled to the processor 114 for displaying the captured and/or processed image data. The camera 143 is suitably mounted on the robotic system 101 for movement relative to the containers 105 by the robotic system. For example, in the illustrated embodiment, the camera 143 is mounted on the end effector 111 for movement with the end effector. It is recognized the camera could be mounted in fixed position relative to the platform within the scope of the invention.

The camera 143 and processor 114 are configured to communicate with one another so the processor can instruct the camera to capture images at appropriate times and receive image data from the camera indicative of the images captured by the camera. The processor 114 for the vision system 141 can suitably be the same processor that controls operation of the robotic system 101, although separate processors could be used within the scope of the invention. Various cameras can be used within the broad scope of the invention. For example, the camera 143 can be a digital camera containing a CCD array (not shown) that converts the captured image into electrical signals. The cameral 143 in the illustrated embodiment is configured to capture monochromatic (e.g., grayscale) images instead of color images for reasons that will be discussed in more detail later, but the camera can be configured to capture color images within the broad scope of the invention.

The machine vision system 141 also includes a light 145 for illuminating the container 105 being imaged by the camera 143. One or more lights having various different configurations, arrangements, and colors can be used within the broad scope of the invention. The lights can be moveable (e.g., mounted on the end effector 111) or fixed (e.g., secured to or within the platform 103) within the scope of the invention. The one or more lights can be positioned to provide bright field illumination, dark field illumination, side lighting, backlighting, and any combinations thereof. FIG. 4 illustrates three optional lights 181, 183, 185 that can be positioned at fixed locations relative to the station for receiving the container 105 holding the frozen sample. For example, fiber optic cables can be routed through the platform or provided on the platform to provide light at locations designated 181, 183, and/or 185. Other types of lights could also be secured on or within the platform at these locations.

The containers 105 are typically transparent or at least translucent so light can pass through the side or bottom of the container and interact with the frozen sample therein. The light 181 at the bottom of the receptacle 106 for receiving the container 105 provides a backlighting option. The light 183 at the top of the container is suitably secured within one of the jaws 108, 110 to provide a side lighting and/or dark field illumination option for the surface of the sample. The light 185 in the side of the receptacle 106 suitably provides a side lighting option below or at the surface of the frozen sample. When the side lighting and/or back lighting options are used, the bores in the frozen sample will typically have a brighter appearance than the frozen sample in the corresponding image. Side lighting and/or back lighting can be useful in detecting real bores that are either filled with or completely obscured by frost or other debris. The machine vision system 141 can include multiple different lights and the processor 114 can be configured to operate the lights sequentially if desired to make use of image data of the frozen sample under different lighting conditions.

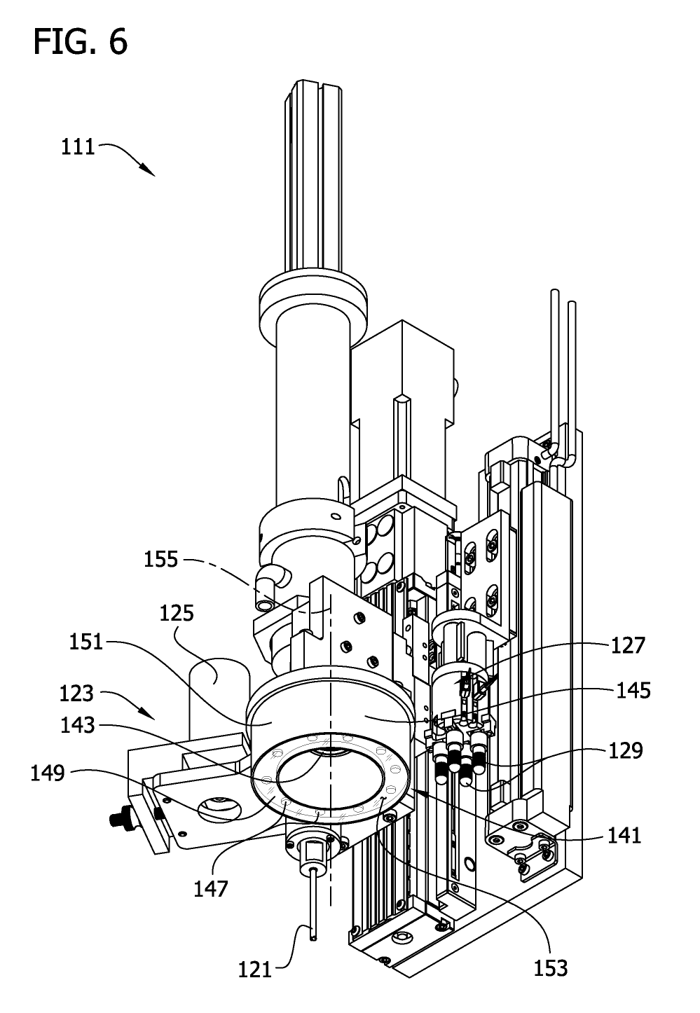

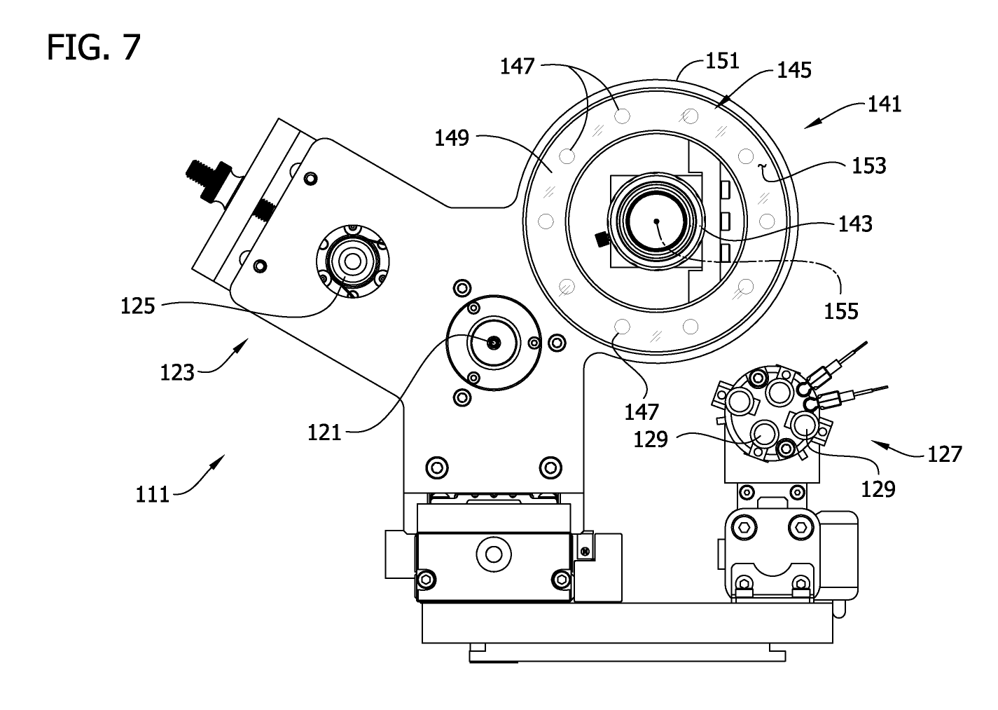

As illustrated in FIGS. 6 and 7, the light 145 in the illustrated embodiment is a ring light. The ring light 145 has a plurality of light sources 147 (e.g., LEDs) arranged in an annular (e.g., circular) pattern. For example, the ring light 145 suitably has a hollow cylindrical housing 151 having a groove 153 in one end. The light sources 147 are positioned in the groove 153 in a recessed position so the housing blocks the direct path of light from the light sources at wide angles therefrom. A cover 149 such as a clear window, transparent or translucent diffuser, or lens can be installed in the groove to enclose the light sources 147 if desired.

In the embodiment illustrated in FIGS. 6-7, the camera 143 is positioned so an optical axis 155 of the camera 143 extends through a central portion of the annular pattern of the ring light 151. For example, the annular ring light 145 suitably has a central axis that is co-linear with the optical axis 155 of the camera. The ring light 145 and camera 143 are suitably arranged so there is no direct path from the light sources 147 in the ring light to the camera. In FIG. 5, for example, the camera 143 has a forward end 157 for receiving light from an object being imaged and the ring light 145 is suitably positioned to extend farther forward than the camera so the light emitted by the ring light is emitted from a position in front of the camera. Also as illustrated in FIG. 5, the edge of the housing 151 of the ring light 145 suitably extends between the light sources 147 and the camera 143 to block the path of light directly from the light sources into the camera.

The processor 114 is configured to receive image data from the camera 143 indicative of the image of the container 105 and the frozen sample therein and to use the image data from the camera to determine one or more locations where a frozen sample core has already been taken from the frozen sample contained in the container. The processor 114 can be configured to use various methods to make this determination. For example, the processor 114 can suitably be configured to evaluate contrast in the image to identify one or more bore candidates and then determine whether or not the one or more bore candidates are likely to be artifacts instead of real bores in the sample using information from the image.

The processor 114 suitably processes the image captured while the container 105 is illuminated with the light 145 in various ways to facilitate this determination. For example, in one embodiment the processor 114 is configured to perform a thresholding filter to the raw image data, apply one or more morphological filters (e.g., erosion, dilation, opening, and/or closing) to the thresholded image, and then apply particle analysis to identify one or more bore candidates.

It is understood that the bore candidates identified by the processor might include some features that are artifacts instead of real bores. For example, the sample surfaces can be blotchy or become blotchy over time (e.g., due to undesired formation of frost crystals on the frozen sample, irregularities in the surface contour of the frozen sample resulting from the speed with which the sample was frozen, pieces of ice and other debris that may accumulate on the upper surface of the frozen sample such as by falling from the cap or sides of the container, etc.). Further, although the real bores resulting from extraction of frozen sample cores are typically very uniform (e.g., circular) in appearance initially, frost crystals that might grow on the frozen sample after it is returned to cold storage can extend into the bore or over the opening at the top of the bore and alter the appearance of the bore. Thus, it has been found that a machine vision system that looks for nice perfectly formed bores and excludes all else from the list of bore candidates results in a significant risk of failure to recognize actual bores that exist in the sample, particularly when the frozen sample is replaced in cold storage for a long time before additional frozen sample cores from that frozen sample are requested.

Accordingly, the processor 114 is suitably configured to use multiple types of information to determine whether or not a bore candidate is likely to be a real bore candidate or an artifact. For example, the processor 114 is suitably configured to use information selected from the group consisting of:

the size of the bore candidate;

the distance between the bore candidate and a center axis of the container;

the angle formed between a first line and a second line, the first line extending between the bore and the center axis of the container and the second line extending between the center axis of the container and another bore candidate;

the relation between the position of the one or more bore candidates and an expected pattern of bores in the sample;

the location of the one or more bore candidates relative to a peripheral edge of the container;

the total number of bore candidates associated with a particular container;

the amount of contrast between the bore candidates and the area surrounding the bore candidates; and

(viii) combinations thereof.

to help determine whether or not a bore candidate is likely to be an artifact or a real bore.

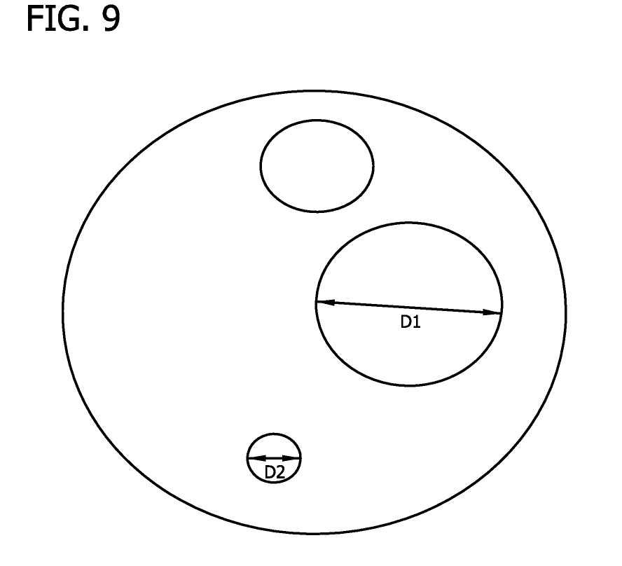

In many cases there will be an expected range of size (e.g., diameter) for the bores formed by extracting a frozen sample core from a frozen sample. However, some bore candidates can be substantially larger or substantially smaller than expected, as illustrated in FIG. 9. Thus, it is possible the processor 114 may be able to determine certain bore candidates are likely to be artifacts on the basis of the size being either too large (e.g., having diameter D1 in FIG. 9) or too small (e.g., having diameter D2 in FIG. 9).

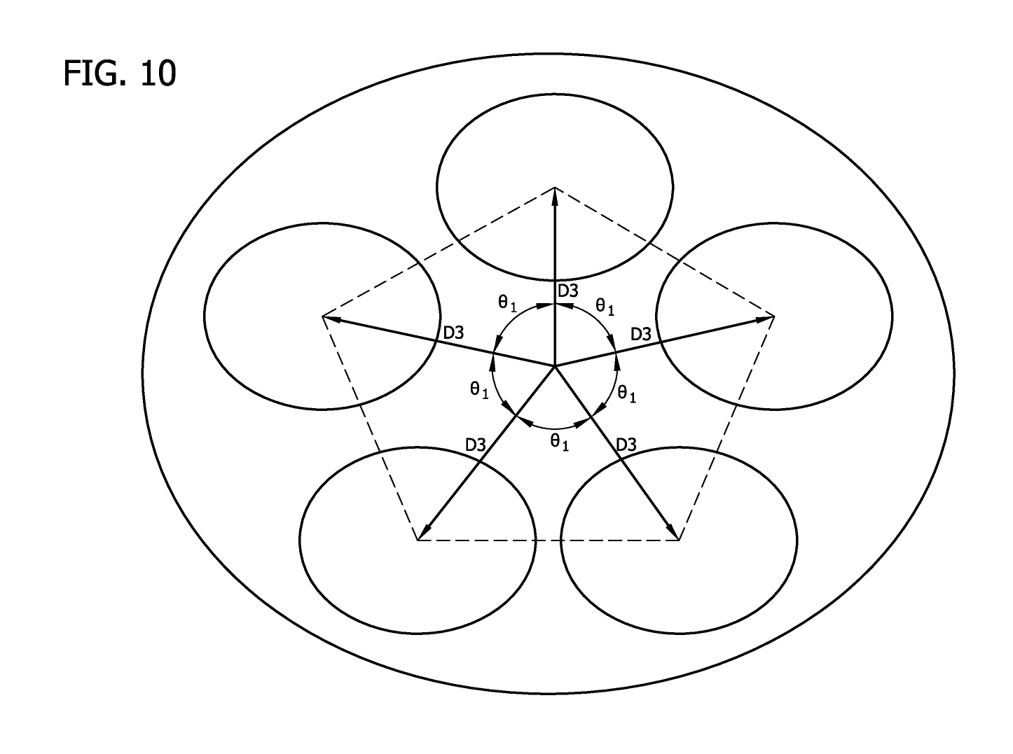

In many cases frozen sample cores will be extracted from the frozen samples according to a pre-determined geometric pattern or a geometric pattern that can be recognized from the captured image data by the processor 114. The geometric pattern can vary depending on what objectives are to be achieved, such as maximizing the number of frozen sample cores that can be extracted from a frozen sample or taking as many frozen sample cores as possible at a particular radial position from the center. FIG. 10 illustrates an example of one geometric pattern in which five sample cores are extracted from a frozen sample. The bores resulting from this pattern are all spaced about the same distance D3 from the center of the container and the angles θ₁ between the lines extending between corresponding points (e.g., the center) in adjacent bores are all about equal. The number of bores in the geometric pattern can vary within the scope of the invention. Although the pattern in FIG. 10 is a regular pattern, meaning the bores are all the same size, are all spaced the same distance from the center, and are all spaced at equal angles, it is understood that the pattern could be irregular within the scope of the invention.

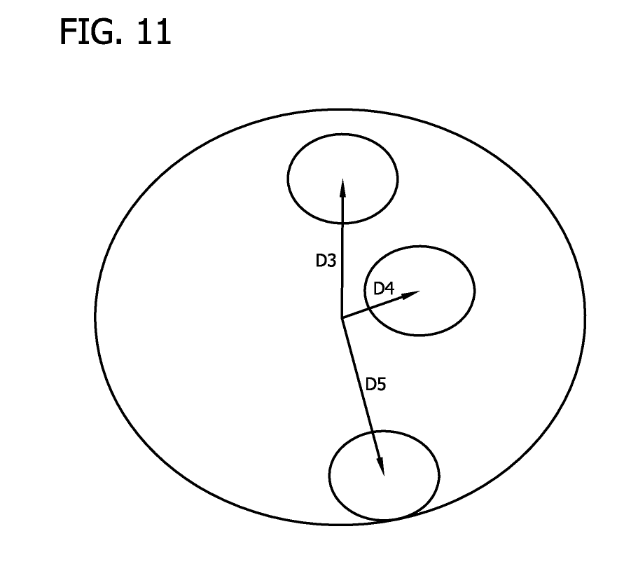

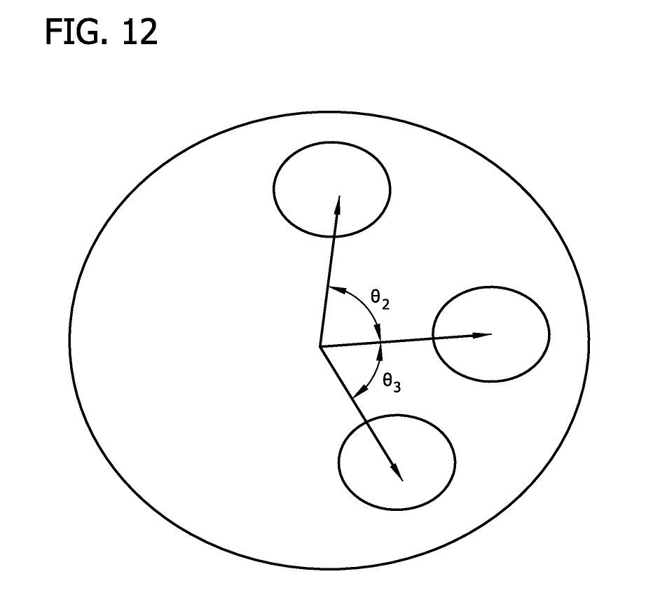

As illustrated in FIG. 11, some bore candidates can be spaced too close to the center (e.g., see distance D4 in FIG. 11) or too far from the center of the container (e.g., see distance D5 in FIG. 11), or conversely, spaced to far or close to the edge of the container if the edge of the container can be detected, to fall within the geometric pattern. Likewise, as illustrated in FIG. 12 the angular spacing between one or more of the bore candidates can be different (either too high θ₂ or too low θ₃) from the expected angular spacing. Thus, the processor 114 can determine certain bore candidates are likely to be artifacts on the basis that the distance between the bore candidate and a center axis of the container (or from an edge of the container) is not within expected limits and/or that the angle formed between lines extending between corresponding points in the two bore candidates (e.g., the center, as illustrated, or an edge) and the center axis of the container is not within expected limits.

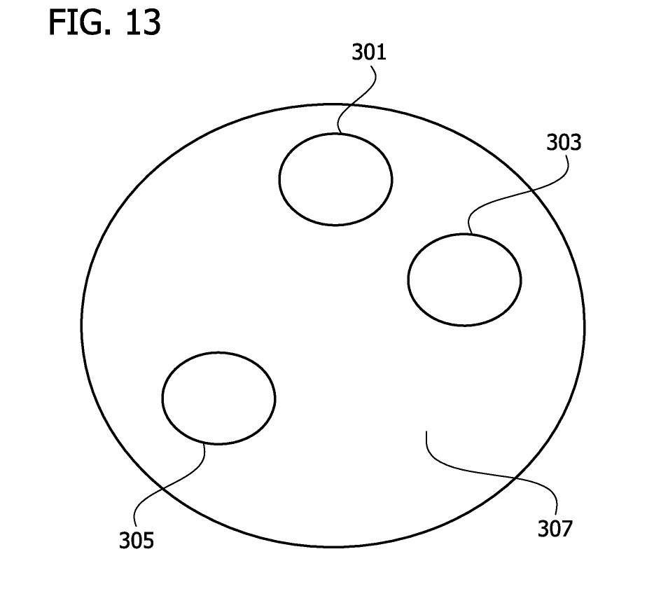

In many cases, frozen sample cores will be extracted from the frozen samples according to a specific orderly sequence. As illustrated in FIG. 10, for example, the frozen sample cores are extracted starting at the top position and then moving clockwise around the geometric patter until the last sample core has been taken. As illustrated in FIG. 13, in some cases one or more of the bore candidates may be out of order even though it could be positioned at a correct place within the geometric pattern. For example, there may be an empty gap 307 in the pattern between one of the bore candidates 305 and other bore candidates 301, 303 indicating that if all of the bore candidates are real bores, the result would be the expected sequence was not followed. In this case, the processor 114 can determine a bore candidate is an artifact on the basis that it is out of order with a sequence according to which frozen sample cores are expected to be extracted from the frozen sample, particularly when multiple bore candidates 301, 303 follow the expected sequence and only one bore candidate 305 is out of sequence.

In some cases, the number of bore candidates can be larger than is expected. The processor 114 is suitably configured to recognize this as an indication of a higher likelihood that one or more of the bore candidates is an artifact. The processor 114 can apply more rigorous standards to help exclude likely artifacts when the number of bore candidates is too high.

Sometimes the amount of contrast between a bore candidate and its surrounding area can help distinguish between real bores and artifacts. For example, a large contrast can be indicative of a very good candidate for a real bore whereas a smaller contrast might indicate one of a set of bore candidate that is questionable on other accounts (e.g., there are too many bore candidates, there are only two bore candidates and they do not follow the expected geometric pattern, etc.) is more likely than the other(s) to be an artifact.

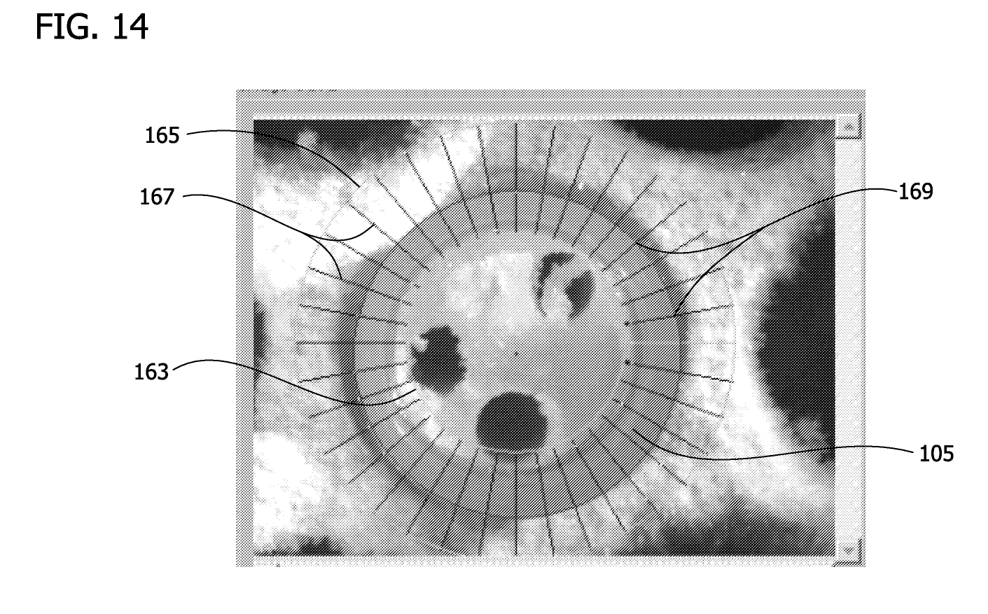

One way the processor can evaluate the positions of the bore candidates is with reference to the position of the center axis of the container 105 holding the frozen sample or alternatively relative to a peripheral edge of the container. The processor 114 can be configured to identify the edge and/or the center of the container 105 in various ways within the scope of the invention. For example, one option is to use an edge finding algorithm to identify the inner or outer peripheral edge of the container 105 and then compute the geometric center of that edge to identify the center of the container. For example, FIG. 14 shows an image of a container 105 with an overlay including a pair of concentric circles 163, 165 and a plurality of radially extending scan lines 167 extending between the circles. The circles 163, 165 define an area to be scanned in an attempt to identify the edge of the container 105. The processor 114 is suitably configured to evaluate the image data to determine points 169 along each line where there is sharp contrast. Each point 169 potentially represents an intersection between the edge of the container 105 and the respective scan line 167. In the case of a successful attempt to identify the edge of a container, a significant number of the points 169 will lie on the same circle (or other shape if the containers do not have circular shapes) in which case the processor 114 concludes the points 169 lying thereon define the edge of the container 105. As used herein in the context of edge finding techniques and using information about the edge of the container to identify and/or evaluate bore candidates, it is understood the edge of the container can refer to the edge of a well or other discrete area within which one frozen sample is stored on a well plate or other container adapted for holding multiple different samples.

Although edge detection techniques can work very well in certain circumstances, edge detection can be impaired when there is low contrast between the edge of the container and the background. This can present a problem when relying solely on edge detection in the context of a machine vision system for a frozen aliquotter because one of the most common colors for containers is white or semi-transparent and white frost can form on surfaces adjacent the containers, which leads to the potential problem that there might be low contrast between the edge of the container and the background in the image.

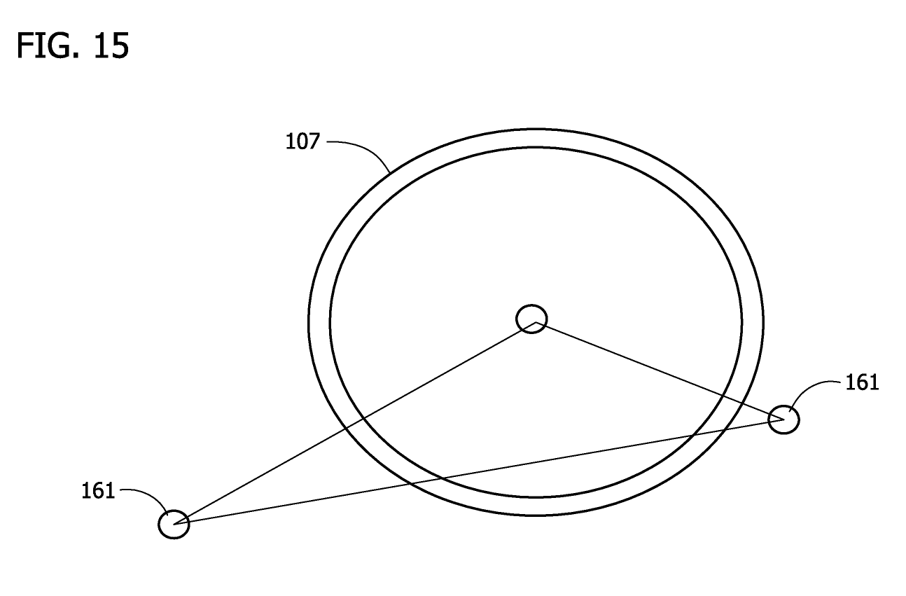

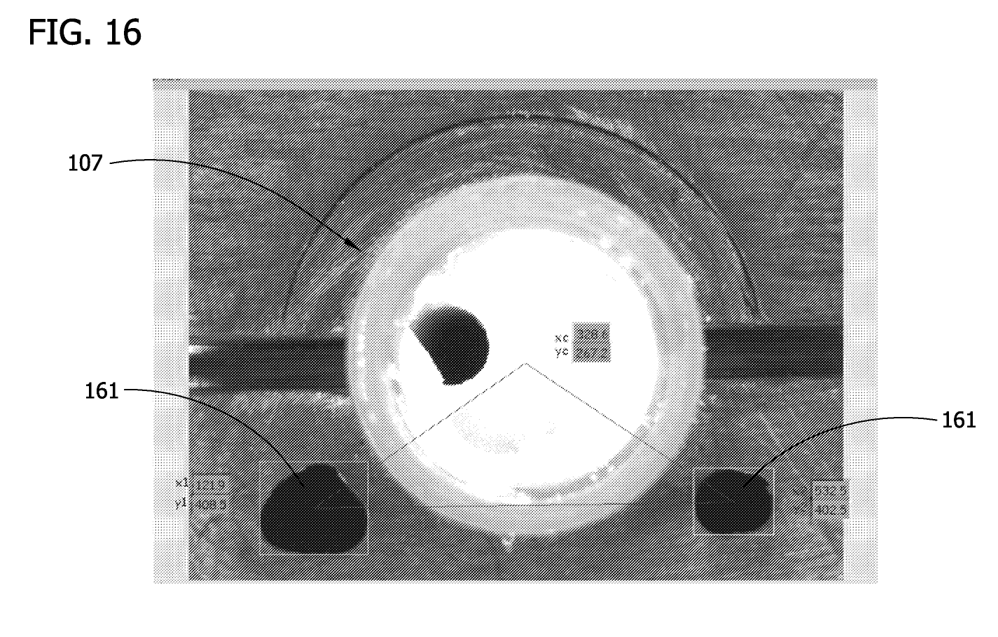

As illustrated in FIGS. 15 and 16, a pair of calibration marks 161 is suitably provided on the platform 103 at fixed positions relative to the source container station 107. The calibration marks 161 can be any structure or marking that has sufficient contrast with the background to allow the calibration marks to be reliably identified by the processor 114 from the image data. For example, the calibration marks 161 can suitably be dark openings, dark colored marking (e.g., dots), or other structures. The calibration marks 161 can suitably be or include heaters (e.g., small low-power resistance heaters) to limit accumulation of frost on the calibration marks, which might obscure the calibration marks.

The processor 114 is suitably configured to use the calibration marks 161 (e.g., in combination with edge detection or without edge detection) to determine whether or not the one or more bore candidates are likely to be artifacts instead of real bores in the frozen sample. The calibration marks 161 are designed to ensure there is strong color contrast between the calibration marks and the surrounding objects in the image even if there is frost formation or other conditions that minimize contrast between the edge of the container 105 and its surrounding in the image data. Because the calibration marks 161 are at fixed positions relative to the station 107 for receiving source containers 105, the processor 114 can determine the position of the bore candidates by comparing their positions to the positions of the calibration marks.

For example, the calibration marks 161 are suitably positioned to form a triangle with the center of the container. The angles α and β formed between a line connecting the calibration marks and the respective lines connecting the calibration marks to the center can be known before the vision system 141 inspects a frozen sample. Accordingly, the processor 114 can be configured to identify the center axis of the container by triangulating the center from the calibration marks. A machine vision system 141 including a processor 114 that is configured to use calibration marks 161 to identify the center of a container is not sensitive to errors in the rotation of the camera or to errors in translation of the camera. In cases where it is not practical to use edge detection to determine the center of the container (e.g., because of low contrast), the processor 114 can be configured to identify the edge of the container 105 and/or the center axis of the container as a function of the position of the calibration marks without detecting any edges of the container. Alternatively, the processor 114 can be configured to both use the calibration marks and peripheral edge detection to identify the center of the container. The processor 114 can be configured to compare the positions of the bore candidates directly to the positions of the calibration marks 161 to determine which bore candidates are likely to be artifacts without computing the relative distances between the bore candidates and the center of the container or the edge of the container without computing the center of the container and/or without computing the edge of the container.

The processor 114 is configured to automatically select a suitable location in the frozen sample from which the robotic system 101 can take another frozen sample core (or in the case of a frozen sample from which no frozen sample cores have been taken yet, it is configured to automatically select the location from which the initial frozen sample core will be extracted) once the processor has determined from the image data whether or not there are any bores in a particular frozen sample and the locations of any such bores. This facilitates taking frozen sample cores from samples that may have already been subjected to previous extractions of frozen sample cores without requiring the processor 114 to have access to any information about the number of previous frozen sample cores that may have been extracted from the sample or the locations within the frozen sample from which any such sample cores have been taken. This eliminates the need for manual intervention to orient the containers 105 is a particular way and greatly reduces the amount of data on a sample that needs to be tracked to successfully manage and process samples when extracting frozen sample cores from frozen samples to fill orders for sample aliquots. It also facilitates the ability to install the robotic system 101 in a bio-bank that has previously used one or more different approaches to sample core extraction (e.g., using a geometric pattern of sample cores that maximizes the number of samples that can be obtained vs. using a geometric pattern of sample cores that results in some or all of the samples being taken from a part of the frozen sample that is a particular radial distance from the center even if this reduces the maximum number of samples cores that can be extracted). Thus, if a bio-bank has previously employed one strategy or particular set of operating procedures for extracting frozen sample cores, the system 101 can still recognize bores in the frozen sample even if the bores are not where they would be expected to be if the previously extracted frozen sample cores had been extracted according to the protocols of the system 101 instead of whatever other protocols were previously in use.

For example, if the processor 114 detects one or more pre-existing bores in the frozen sample, the processor can be configured to select a location for the next frozen sample core that continues the geometric pattern that has already been started. Another option if it is desired that the next sample core be taken from a particular radial location in the frozen sample is that the processor 114 can be configured to select a location that is the desired radial distance from the center of the container and also sufficiently spaced from existing bores in the frozen sample. The processor 114 can be configured so a user can select which of these options is used for any particular container or set of containers.

The processor 114 is also configured to select an appropriate initial geometric pattern for the locations from which a plurality of frozen sample cores will be extracted if the processor determines there are no existing bores in the frozen sample. The processor 114 can be configured to select a geometric pattern that maximizes the number of frozen sample cores that can be taken from the frozen sample and/or the processor can be configured to select a geometric pattern that results in one or more frozen sample cores (e.g., all frozen sample cores) being taken from a particularly desired radial distance from the center of the container. The processor 114 can be configured to allow a user to select which of several different strategies will be used for planning the geometric pattern of the locations from which frozen sample cores are to be extracted for different containers or sets of containers. If desired, the processor 114 can be configured to display the geometric pattern selected by the processor and/or the location(s) selected by the processor as the site(s) for frozen sample extraction(s) to facilitate confirmation and/or intervention by a human operator.

It has been determined that the color of light emitted by the light 145 can be important. In general, better results are obtained when the light used to illuminate the frozen sample matches the color of the frozen sample. For example, the color of the light used to illuminate the frozen sample is suitably the same as the color of the sample or no more different from the color of the sample than one of the two adjacent colors on an RGB color wheel having six colors arranged in the following order extending around the wheel: red, yellow, green, cyan, blue, magenta, and then back to red. For example, a red light works well with red samples, orange samples, and yellow samples. Because there are large numbers of blood (red) and urine (yellow or orange) samples that have been frozen for research, it is anticipated that it can be desirable for the light 145 to emit red light for illuminating the frozen sample. It is also anticipated that it will be desirable in some cases for the light to emit green light or blue light. However, the light can emit any color light within the broad scope of the invention.

In one embodiment, the light 145 includes red light emitting elements, blue light emitting elements, and green light emitting elements and the intensity of light emitted from the red, blue, and green light emitting elements is selectively adjustable to allow any of multiple different colors of light to be selected as the color of light that is used to illuminate the samples. The light sources 147 can include some light sources that emit only red light, other light sources that emit only green light, and other light sources that emit only blue light. Another possibility is that the light sources include multicolor LEDs, each which is operable to emit red light, green light, blue light and combinations thereof.

In the case that the color of light can be adjusted the processor 114 can suitably be configured to receive input about the color of the samples in the containers and adjust the color of the light emitted by the light to reduce a difference between the color of the samples and the color of the light emitted by the light. For example, the vision system 141 can include a user interface configured to allow a user to input information about the color of the samples and the processor 114 can be configured to adjust the color of the light to match the color input by the user. Another option is that the camera 143 can be adapted to capture a color image of the sample (or a representative sample of a group of samples) and the processor 114 can be configured to adjust the color of the light to match the color of the sample in the captured color image. The processor suitably adjust the color of the light used to illuminate the sample to white when capturing the image that will be used to determine the color of the sample to facilitate accurate color detection and then adjusts the color of the light to match the color of the sample. In some cases it may be known that an entire set of samples will be similar in color, in which case the processor can be configured to capture a color image of one of the samples to assess the color of all of the samples in that set and adjust the color once to match the color of all the samples in the set.

Although the vision system can be configured so the camera captures color images of the frozen samples and the processor uses information from the color images to identify where frozen sample cores have already been taken within the scope of the invention, surprisingly good results are obtained when the vision system is configured so the camera captures a monochromatic (e.g., grayscale) image of the frozen sample (even when the light illuminating the sample is other than white, e.g., selected to match the color of the sample) and the processor uses the grayscale image to determine whether or not frozen samples cores have already been taken from the frozen sample and, if so, to identify the locations from which the frozen sample cores have already been taken. Digital cameras are available that can capture both grayscale images and color images, so it is possible that the camera captures one or more color images (e.g., to identify the color of the sample so the light used to illuminate the sample can be adjusted to match the color of the sample) and also captures grayscale images for use by the processor to identify locations where bores exist within the frozen samples.

The machine vision system 141 is suitably a component of a calibration system configured to calibrate the robotic system 101. As illustrated in FIGS. 1-3, the platform 103 has one or more fixed targets 171 positioned thereon. The camera 143 is mounted on the robotic system 101 so it can be moved to capture an image of each of the fixed targets 171. The processor is suitably configured to receive image data from the camera indicative of images of the target(s) formed by the camera and calibrate the robotic system 101 using an image of the one or more fixed targets 171 on the platform 103. As illustrated in FIG. 1, at least one of the targets 173 has an image (e.g., a cross hair) having a point or intersection of lines for calibration in the x and y directions and a shape (e.g., circle) having a known size for calibration in the z direction. The calibration system suitably has a user interface (not shown) configured to allow a user to guide the camera from a position that is not in registration with one of the targets (e.g., so a reticule overlaying the captured image is not aligned with the cross hair) toward a position that is in registration with said target (e.g., so the reticule is aligned with the cross hair).

Also, as illustrated in FIGS. 1-3, one of the targets 171 (e.g., the target 173 having the cross hair and circle) is secured to an upper surface of the work deck outside the recessed area 115 for receiving the trays. Further, one of the targets 175 is suitably secured to a bottom of the recessed area (e.g., between the trays 117 and adjacent the stations 107, 109, as illustrated in FIG. 3) for receiving the containers 105. In illustrated embodiment, the target 175 in the recessed area 115 also includes a cross hair.

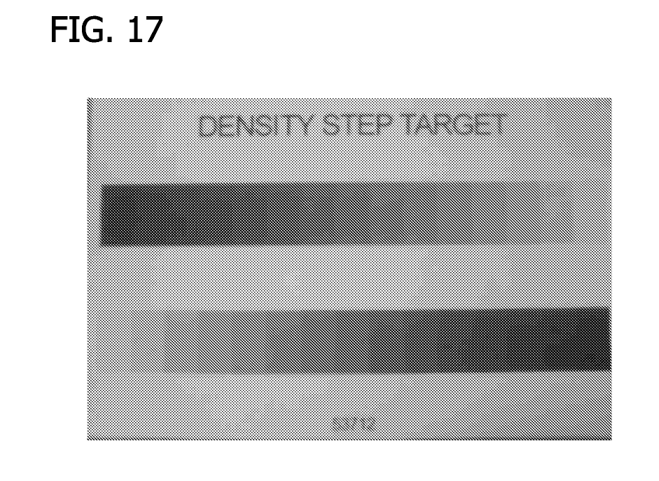

Another of the targets in the illustrated embodiment is suitably a density step target 177 (see FIG. 17) having an image including one or more series of blocks arranged from lighter shades to darker shades for use calibrating light/dark settings for the camera 143.

The processor 114 is suitably configured to use multiple additional features on the platform 103 as targets to help calibrate the robotic system 101. For example, the processor 114 is suitably configured to calibrate the robotic system 101 using images of multiple features on the platform 103 selected from the group consisting of

the station 107 for receiving a container 105 from which a frozen sample core is to be taken;

the station 109 for receiving a container 105 in which a frozen sample core is to be deposited;

the station 119 for cleaning a coring probe 121 of the robotic system 101;

one or more sample trays 117 on the platform 103 for holding the containers 105; and

combinations thereof.

For example, FIG. 3 illustrates 13 calibration points that can be used according to one particular embodiment of the calibration system, with each of calibration points being labeled consecutively from 201-213. Point 201 corresponds to the target 175 on the platform 103 in the recessed area 115. Points 201, 202, and 203 correspond to the stations 107, 109 for receiving the containers 105 and the station 119 for washing the coring probe 121, respectively. Points 204-208 correspond to various points (e.g., points at the corners) of one of the trays 117a and points 209-212 correspond to various points (e.g., points at the corners) of another of the trays 117b. Point 213 corresponds to the target 173 on the deck of the platform 103. The points included in the calibration are suitably selected so they collectively extend over at least a substantial portion of the operating envelop, but the specific points used in the calibration process can vary within the scope of the invention.

The calibration system is suitably configured to complete calibration of the robotic system 101 without any physical contact between (i) the end effector 111 or and any components moveable with the end effector and (ii) the platform 103 or components on the platform.

The calibration system is also suitably configured to determine the positions of the camera 143, coring probe 143, and gripper 127 relative to one another to compensate for variations in the positional offsets associated with the camera, probe, and gripper. For example, the calibration system is suitably configured so a user can direct movement of the end effector 111, to bring each of the camera 143, coring probe 121, and gripping system 127 into registration with a target 171 or other reference point and provide an indication to the processor 114 each time one of them is in registration therewith. This allows the processor 114 to compute offsets between these components that account for positional variations that may result during assembly of the robotic system 101 or for any other reason. This facilitates more accurate position of the components of the robotic system 101.

During initial installation of the robotic system 101, and from time to time thereafter as may be needed, the machine vision system 141 is suitably used to calibrate the robotic system. The robotic drive system 113 moves the camera 143 into a position that is estimated by the processor to be in registration with one of the targets 171. Then, image data from the camera 143 is used (either by the processor or a user) to instruct the robotic drive system 113 to adjust the position of the camera until it is in registration with the target. If the target 171 includes a circle or other shape having a known size for calibration in the z-axis, the image data from the camera 143 is used to instruct the robotic drive system (either by the processor or a user) to raise or lower the camera until the size of the shape in the image captured by the camera indicates the camera is the proper distance from the target in the z-direction. Calibration in the Z-direction could instead be achieved using a lens setting for the camera 143 having a known focal length and then adjusting the height of the camera until the image is in focus. When the camera 143 is in registration with the target 171 and the correct distance from the target, the processor records positional information from the robotic system 101 (e.g., data from encoders and other devices that provide positional feedback about the position of various components of the robotic system) and designates that information as corresponding to a set point corresponding to respective target. The process is repeated for each of the targets 171. For example, in the embodiment illustrated in FIG. 3 the process is repeated for each of the calibration points 201-213.

Although the targets 171 and/or calibration points can be positioned at various locations on the platform 103, in the illustrated embodiment, the targets suitably include one target 173 on the upper surface of the deck of the platform and another target 175 in the recessed area of the platform. The targets 171/calibration points suitably include multiple targets including at least one of:

the station 107 for receiving the container 105 from which a frozen sample core is to be taken;

the station 109 for receiving the container 105 in which a frozen sample core is to be deposited;

the station 119 for cleaning the coring probe 121;

one or more trays 117a, 117b on the platform 103 for holding the containers 105; and combinations thereof.

For example, in one embodiment the calibration targets 171 and calibration points include each of points 201-213 on FIG. 3.

The density step target 177 is also used during the calibration process to adjust camera settings and light intensity to provide standard image capturing conditions. The light 145 is turned on and the diaphragm of the camera 143 and/or intensity of electric current supplied to the light are adjusted while the camera captures images of the density step target 177 until a particular shaded block on the density step target is read as a certain gray level by the camera 143. For example, good results have been obtained when the light 145 and camera 143 are adjusted so the third lightest color block on a standard density step target is read by the camera as 200 gray level.

The robotic system 101 is also calibrated to adjust for any variations in the offset between the positions of the camera 143, the coring probe 121, and the gripping system 127. For example, the camera 143 is first positioned in registration with one of the targets 171 or other reference point on the platform 103, at which point a user provides an indication to the processor 114 that the camera is in registration therewith. Then a user adjusts the position of the end effector 111 until the coring probe 121 is in registration with the target 171 or reference point and provides an indication to the processor 114 that the coring probe is in registration therewith. Finally, the user adjusts the position of the end effector until the gripper system 127 is in registration with the target 171 or other reference point and provides an indication to the processor that the gripper system is in registration therewith. The order in the steps of this method is not important. The processor 114 determines the positional offset between the camera 143, coring prove 121, and gripper assembly 127 using the information provided in this process. The entire calibration process is suitably completed without requiring any contact between the end effector 111 or any components moveable with the end effector and the platform 103 or any components on the platform.

To extract frozen sample cores from the frozen samples, a set of containers 105 containing frozen samples is placed on the platform 103. For example, one or more trays 117a can be loaded with sample containers 105 and then placed on the platform 103 (e.g., in the recessed area 115). A set of empty containers 105 for receiving frozen sample cores after they are extracted is loaded into one or more additional trays 117b and placed on the platform 103. The robotic system 101 uses the gripper system 127 to move one of the containers 105 containing a frozen sample to the station 107 for receiving containers from which frozen sample cores are being extracted and moves one of the empty containers to the station 109 for receiving destination containers into which the frozen sample cores are to be deposited.

Then the robotic system moves the camera 143 into position over the station 107 for holding the containers 105 containing frozen sample while frozen sample cores are extracted from them. The light 145 is used to illuminate the container 105 at the station 107 and the frozen sample contained therein. If the machine vision system 141 includes the option of adjusting the color of the light 145, the color of the frozen sample is determined (e.g., using image data from the camera and/or user input) and the color of the light is adjusted to match the color of the frozen sample, as described above. For example, if the frozen sample is red, orange, or yellow, the light 145 can be adjusted to emit red light. Likewise, if additional lighting options are used, additional images of the container 105 are captured with one or more of the lights 181, 183, 185 providing illumination.

The camera 143 captures one or more raw images of the illuminated container 105 and frozen sample. The raw image is suitably processed to facilitate recognition of bore candidates. For example, a thresholding filter is suitably applied to the raw image obtained with illumination from light 145. A morphological filter is also applied to the image. After the image has been filtered a particle analysis imaging algorithm is performed to recognize any bore candidates. The processor then uses the image data to evaluate whether or not any bore candidates are actual bores or just artifacts in order to determine whether or not any frozen sample cores have already been taken from the frozen sample and, if so, to identify the location(s) from which they were taken.

If the option of using calibration marks 161 to evaluate the positions of the bore candidates is used, the method suitably includes heating the calibration marks using the low-power resistance heaters to ensure the calibration marks are not obscured by frost.

Once the processor 114 has identified the bore candidates and determined which bore candidates are likely to be artifacts and which are likely to be real bores, the processor automatically selects a position from which a frozen sample core will be extracted, accounting for the position of pre-existing bores in the frozen sample if there are any. Then the processor 114 instructs the robotic system 101 to move the coring probe 121 into position over the selected location and instructs the sample extraction system to extract a frozen sample core from the location. Consequently the coring probe 121 is extended into the frozen sample (e.g., while rotating if the sample extraction system 123 uses a drilling action) and then withdrawn from the frozen sample with the frozen sample core contained therein. The robotic system 101 moves the coring probe 121 into position over the top of the container 105 at the station 109 for holding the destination containers and ejects the frozen sample core from the coring probe into the destination container. If more than one frozen sample core is needed to provide enough material for the aliquot that has been ordered, the frozen sample core extraction process is repeated at another suitable location within the frozen sample, as automatically determined by the processor, until a sufficient amount of sample material has been deposited in the destination container 105.

The following discussion is intended to provide a brief, general description of a suitable processing environment in which aspects of the invention may be implemented. Although not required, aspects of the invention will be described in the general context of computer-executable instructions, such as program modules, being executed by computers or processors in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the invention may be practiced in network computing environments with many types of computer system configurations, including personal computers, hand-held devices, multi-processor systems, microprocessor-based or programmable consumer electronics, network PCs, minicomputers, mainframe computers, and the like. Aspects of the invention may also be practiced in distributed computing environments where tasks are performed by local and remote processing devices that are linked (either by hardwired links, wireless links, or by a combination of hardwired or wireless links) through a communications network. In a distributed computing or processing environment, program modules may be located in both local and remote memory storage devices.

An exemplary system for implementing aspects of the invention includes a general purpose computing device in the form of a conventional computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory includes read only memory (ROM) and random access memory (RAM). A basic input/output system (BIOS), containing the basic routines that help transfer information between elements within the computer, such as during start-up, may be stored in ROM.

The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The magnetic hard disk drive, magnetic disk drive, and optical disk drive are connected to the system bus by a hard disk drive interface, a magnetic disk drive-interface, and an optical drive interface, respectively. The drives and their associated computer-readable media provide nonvolatile storage of computer-executable instructions, data structures, program modules, and other data for the computer. Although the exemplary environment described herein employs a magnetic hard disk, a removable magnetic disk, and a removable optical disk, other types of computer readable media for storing data can be used, including magnetic cassettes, flash memory cards, digital video disks, Bernoulli cartridges, RAMs, ROMs, and the like.

Program code means comprising one or more program modules may be stored on the hard disk, magnetic disk, optical disk, ROM, and/or RAM, including an operating system, one or more application programs, other program modules, and program data. A user may enter commands and information into the computer through keyboard, pointing device, or other input devices, such as a microphone, joy stick, game pad, satellite dish, scanner, or the like. These and other input devices are often connected to the processing unit through a serial port interface coupled to system bus. Alternatively, the input devices may be connected by other interfaces, such as a parallel port, a game port, or a universal serial bus (USB). A monitor or another display device is also connected to system bus via an interface, such as video adapter. In addition to the monitor, personal computers typically include other peripheral output devices (not shown), such as speakers and printers.

The computer may operate in a networked environment using logical connections to one or more remote computers, such as remote computers. Remote computers may each be another personal computer, a server, a router, a network PC, a peer device or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

In one mode of operation, a frozen sample that is contained in a container 105 is positioned (e.g., by the robotic system) at the station 107 on the platform 103 having calibration marks 161 in fixed positions relative to the station. The camera 143 captures an image of the container 105 and the sample therein while the container 105 is received at the station 107. The processor 114 determines one or more locations where a frozen sample core has already been taken from the frozen sample contained in the container 105 by: (a) evaluating contrast in the image to identify one or more bore candidates in the frozen sample; and (b) using information about the position of the calibration marks relative to the bore candidates to determine whether or not the one or more candidates are likely to be artifacts instead of real bores in the frozen sample. The frozen sample core is taken from the sample at a location from which no frozen sample core has already been taken, as determined by the processor.

In another mode of operation, the camera captures an image of a container 105 containing a frozen sample. The processor 114 uses the captured image to determine one or more locations where a frozen sample core has already been taken from the frozen sample contained in the container by: (a) evaluating contrast in the image to identify one or more bore candidates; and (b) determining whether or not the one or more bore candidates are likely to be artifacts instead of real bores in the frozen sample. To make this determination, the processor 114 uses information including at least one of the following:
the size of the bore candidate;
the distance between the bore candidate and a center axis of the container 105;
the angle formed between a first line and a second line, the first line extending between the bore and the center axis of the container and the second line extending between the center axis of the container and another bore candidate;
the relation between the position of the one or more bore candidates and an expected pattern of bores in the frozen sample;
the location of the one or more bore candidates relative to a peripheral edge of the container;
the number of bore candidates identified;
the amount of contrast between the bore candidates and the surrounding areas; and
combinations thereof.

The system takes a frozen sample core from the frozen sample at a location from which no frozen sample core has already been taken, as determined by the processor.

In yet another mode of operation, the robotic system 101 is calibrated by using the camera 143 to capture an image of one or more fixed targets 171 on the platform 103. The processor 114 uses an image of the one or more targets 171 to calibrate the robotic system. Then the same camera 143 is used to capture an image of one or more containers 105 while the containers are supported by the platform to determine whether or not one or more frozen sample cores has already been taken from the frozen sample.

In still another mode of operation, the robotic system 101 is operated to move the camera 143 relative to a first one of the containers 105 so the camera is directed at the frozen sample in the first container. The frozen sample in the container 105 is illuminated using the ring light 145. The camera 143 is used to capture an image of the illuminated frozen sample. The processor 114 evaluates contrast in the captured image and processes the image to identify one or more bore candidates in the captured image. The processor 114 determine whether or not the bore candidates are likely to be artifacts or real bores in the frozen sample. The robotic system 101 moves the camera relative to a second of the containers 105 so the camera is directed at the frozen sample in the second container and the process is repeated.

In yet another mode of operation, the robotic system 101 moves the camera 143 relative to a first one of the containers 105 so the camera is directed at the frozen sample in the first container. The frozen sample in the container 105 is illuminated with a colored light. The camera 143 captures a grayscale image of the illuminated frozen sample. The processor 114 evaluates contrast in the captured image and processes the image to identify one or more bore candidates in the captured image. The processor 113 determines whether or not the bore candidates are likely to be artifacts or real bores in the frozen sample. The robotic system 101 moves the camera 143 relative to a second of the containers 105 so the camera is directed at the frozen sample in the second container. The process is repeated.

In another mode of operation, the a robotic system 101 moves the camera 143 relative to a first one of the containers 105 so the camera is directed at the frozen sample in the first container. The frozen sample in the container 105 is illuminated with a light 145 that has a color selected to match the color of the frozen sample. The camera 143 captures an image of the illuminated frozen sample. The processor 114 evaluates contrast in the captured image and processes the image to identify one or more bore candidates in the captured image. The processor 114 determines whether or not the bore candidates are likely to be artifacts or real bores in the frozen sample. The robotic system moves the camera 143 relative to a second of the containers 105 so the camera is directed at the frozen sample in the second container and the process is repeated.

In another mode of operation the robotic system 101 to positions one of the containers 105 on the platform 103 at a station 107 for receiving the container while a frozen sample core is extracted from the frozen sample contained in the container. One or more of the lights 181, 183, 185 provides at least one of back lighting and side lighting for the container 105. The camera 143 to captures an image of the frozen sample while it is sidelit and/or backlit. The processor 114 evaluates contrast in the captured image and processes the image to identify one or more bore candidates in the captured image.

The modes of operation described above can be used in combination or they can be used separately within the scope of the invention.

When introducing elements of the present invention of the preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the foregoing, it will be seen that the several objects of the invention are achieved and other advantageous results attained.

As various changes could be made in the above constructions without departing from the scope of the invention, it is intended that all matter contained in the above description and shown in the accompanying drawings shall be interpreted as illustrative and not in a limiting sense.

1-21. (canceled)

22. A machine vision system for use with a robotic system for taking a plurality of frozen sample cores from frozen samples that are each contained in a respective container, the machine vision system comprising:
a platform;
a camera for capturing an image of one of the containers while it is on the platform; and
a processor configured to receive image data from the camera indicative of the image captured by the camera and to determine one or more locations where a frozen sample core has already been taken from the frozen sample contained in the container by: (a) evaluating contrast in the image to identify one or more bore candidates; and (b) determining whether or not the one or more bore candidates are likely to be artifacts instead of real bores in the sample using at least one of the following:
(i) the size of the bore candidate;
(ii) the distance between the bore candidate and a center axis of the container;
(iii) the angle formed between a first line and a second line, the first line extending between the bore and the center axis of the container and the second line extending between the center axis of the container and another bore candidate;
(iv) the relation between the position of the one or more bore candidates and an expected pattern of bores in the sample;
(v) the location of the one or more bore candidates relative to a peripheral edge of the container;
(vi) the number of bore candidates identified;
(vii) the amount of contrast between the bore candidates and the area surrounding the bore candidates; and
(viii) combinations thereof.

23. A machine vision system as set forth in claim 22 wherein the processor is configured to determine whether or not the one or more bore candidates are likely to be artifacts instead of real bores in the frozen sample using information about location of the one or more bore candidates relative to a peripheral edge of the container.

24. A machine vision system as set forth in claim 22 wherein the processor is configured to determine whether or not the one or more bore candidates are likely to be artifacts instead of real bores in the frozen sample using information about the size of the one or more bore candidates.

25. A machine vision system as set forth in claim 22 wherein the processor is configured to determine whether or not the one or more bore candidates are likely to be artifacts instead of real bores in the frozen sample using information about the distance between the bore candidate and a center axis of the container.

26. A machine vision system as set forth in claim 22 wherein the processor is configured to determine whether or not the one or more bore candidates are likely to be artifacts instead of real bores in the sample by using information about the angle formed between a first line and a second line, the first line extending between the bore and the center axis of the container and the second line extending between the center axis of the container and another bore candidate.

27. A machine vision system as set forth in claim 22 wherein the processor is configured to determine whether or not the one or more bore candidates are likely to be artifacts instead of real bores in the frozen sample by using information about the relation between the position of the one or more bore candidates and an expected pattern of bores in the frozen sample.

28. A machine vision system as set forth in claim 22 wherein the processor is configured to determine whether or not the one or more bore candidates are likely to be artifacts instead of real bores in the frozen sample by using information about the number of bore candidates identified.

29. A machine vision system as set forth in claim 28 wherein the processor is configured to determine whether or not the one or more bore candidates are likely to be artifacts instead of real bores in the frozen sample by using information about the amount of contrast between the bore candidates and the areas surrounding the bore candidates.

30. A method of taking a frozen sample core from a frozen sample that is contained in a container, the method comprising:
capturing an image of the container;
using the captured image to determine one or more locations where a frozen sample core has already been taken from the frozen sample contained in the container by: (a) evaluating contrast in the image to identify one or more bore candidates; and (b) determining whether or not the one or more bore candidates are likely to be artifacts instead of real bores in the frozen sample using information including at least one of the following:
(i) the size of the bore candidate;
(ii) the distance between the bore candidate and a center axis of the container;
(iii) the angle formed between a first line and a second line, the first line extending between the bore and the center axis of the container and the second line extending between the center axis of the container and another bore candidate;
(iv) the relation between the position of the one or more bore candidates and an expected pattern of bores in the frozen sample;
(v) the location of the one or more bore candidates relative to a peripheral edge of the container;
(vi) the number of bore candidates identified;
(vii) the amount of contrast between the bore candidates and the surrounding areas; and
(viii) combinations thereof; and
taking the frozen sample core from the sample at a location from which no frozen sample core has already been taken, as determined in the determining step.

31. A method as set forth in claim 30 wherein the determining comprises using information about location of the one or more bore candidates relative to a peripheral edge of the container.

32. A method as set forth in claim 30 wherein the determining comprises using information about the size of the one or more bore candidates.

33. A method as set forth in claim 30 wherein the determining comprises using information about the distance between the bore candidate and a center axis of the container.

34. A method as set forth in claim 30 wherein the determining comprises using information about the angle formed between a first line and a second line, the first line extending between the bore and the center axis of the container and the second line extending between the center axis of the container and another bore candidate.

35. A method as set forth in claim 30 wherein the determining comprises using information about the relation between the position of the one or more bore candidates and an expected pattern of bores in the frozen sample.

36. A method as set forth in claim 30 wherein the determining comprises using information about the number of bore candidates identified.

37. A method as set forth in claim 30 wherein the determining comprise using information about the amount of contrast between the bore candidates and the surrounding areas.

38-100. (canceled)

101. A machine vision system as set forth in claim 23 wherein the processor is configured to determine whether or not the one or more bore candidates are likely to be artifacts instead of real bores in the frozen sample using information about the size of the one or more bore candidates.

102. A machine vision system as set forth in claim 101 wherein the processor is configured to determine whether or not the one or more bore candidates are likely to be artifacts instead of real bores in the frozen sample using information about the distance between the bore candidate and a center axis of the container.

103. A machine vision system as set forth in claim 102 wherein the processor is configured to determine whether or not the one or more bore candidates are likely to be artifacts instead of real bores in the sample by using information about the angle formed between a first line and a second line, the first line extending between the bore and the center axis of the container and the second line extending between the center axis of the container and another bore candidate.

104. A machine vision system as set forth in claim 103 wherein the processor is configured to determine whether or not the one or more bore candidates are likely to be artifacts instead of real bores in the frozen sample by using information about the relation between the position of the one or more bore candidates and an expected pattern of bores in the frozen sample.

105. A machine vision system as set forth in claim 104 wherein the processor is configured to determine whether or not the one or more bore candidates are likely to be artifacts instead of real bores in the frozen sample by using information about the number of bore candidates identified.
